(19) United States
(12) Patent Application Publication
(10) Pub. No.: US 2006/0243824 A1
(43) Pub. Date: Nov. 2, 2006

(54) Paint container of air brush

(76) Inventor: Chung-Tsuen Juo, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/118,426

(22) Filed: May 2, 2005

(51) Int. Cl. B05B 1/28

(52) U.S. Cl. 239/290; 118/302

(57) ABSTRACT

An air brush includes a brush member with a paint container thereon. The paint container has a cup a lid and a connector connecting the cup and the lid to make the lid always connects the cup even when the lid is opened.

### BACKGROUND OF THE INVENTION

1. Field of the Invention

The present invention relates generally to an air brush, and more particularly to an air brush having a paint container with lid.

2. Description of the Related Art

FIG. 4 and FIG. 5 show a conventional air brush including a brush member 8, a paint container 9, a gas injection member 93 and a control assembly 94. The brush member 8 has a chamber 81 therein and defines a head portion 82 and a rear portion 83 at opposite ends thereof. A nozzle 821 is provided at the head portion 82 of the brush member 8. The paint container 9 has a cup 91 to receive paint therein. The cup 91 has an opening 911 at a top thereof and a bore 912 at a bottom thereof. The bore 912 communicates the cup 91 with the chamber 81 in the brush member 8. A lid 91 is provided on the cup 91 to seal the opening 911. The gas injection member 93 is connected to the chamber 81 of the brush member 8 to issue high pressure gas to an air channel 84 in the brush member 8. The gas injection member 93 has a valve 931 therein to close and open the gas injection member 93. The valve 94 is received in the brush member 8 with a needle extended to the nozzle 821 to control the paint flow.

To fill paint in the paint container 9, the lid 92 has to be taken off, and put on the cup 91 again after the paint had been filled. Some users lose the lid 92 when fills the paint, but the stores do not sell the lid 92 only. The user has to buy a new air brush only because of the miss of the lid.

### SUMMARY OF THE INVENTION

The primary objective of the present invention is to provide a paint brush, which the lid is fastened to the brush to prevent it from losing.

According to the objective of the present invention, an air brush comprises a brush member having a head portion, on which a nozzle is provided, and an air channel communicated with the nozzle. A paint container is provided on the brush member, which has a cup and a lid, wherein the cup has an opening at a top and a bore at a bottom communicated with the brush member. A gas injection member is connected to the brush member and communicated with the air channel to issue a high pressure gas to the nozzle. A valve assembly is received in the gas injection member to control a paint flow in the nozzle. A connector connects the cup and the lid to make the lid always connects the cup even when the lid is opened.

### BRIEF DESCRIPTION OF THE DRAWINGS

FIG. 1 is an exploded view of a preferred embodiment of the present invention;

FIG. 2 is a sectional view of the preferred embodiment of the present invention, showing the lid closed;

FIG. 3 is a sectional view in part of the preferred embodiment of the present invention, showing the lid opened;

FIG. 4 is an exploded view of the conventional air brush, and

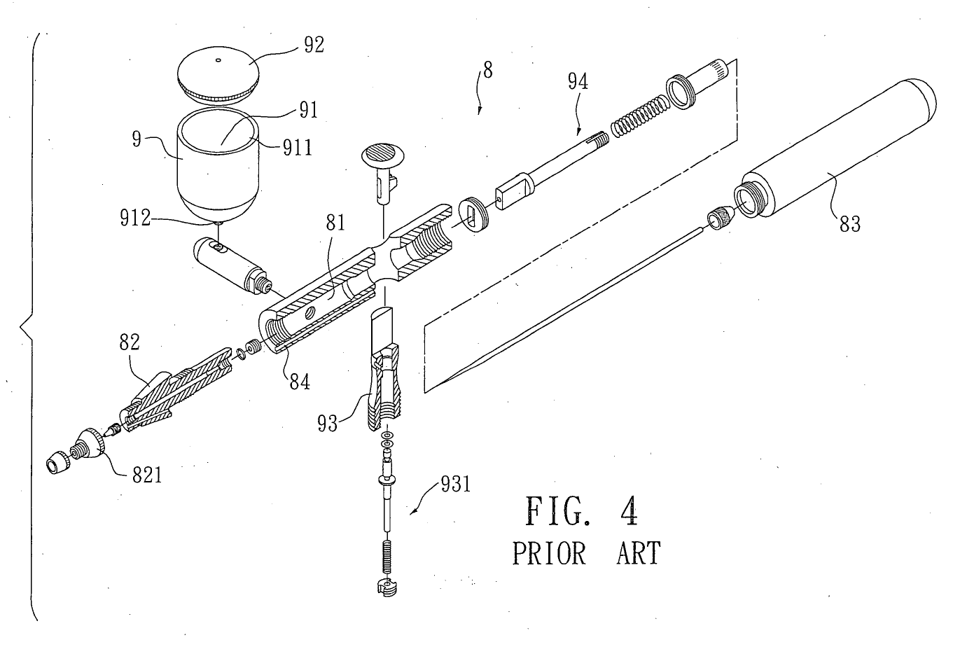

FIG. 5 is a sectional view of the conventional air brush.

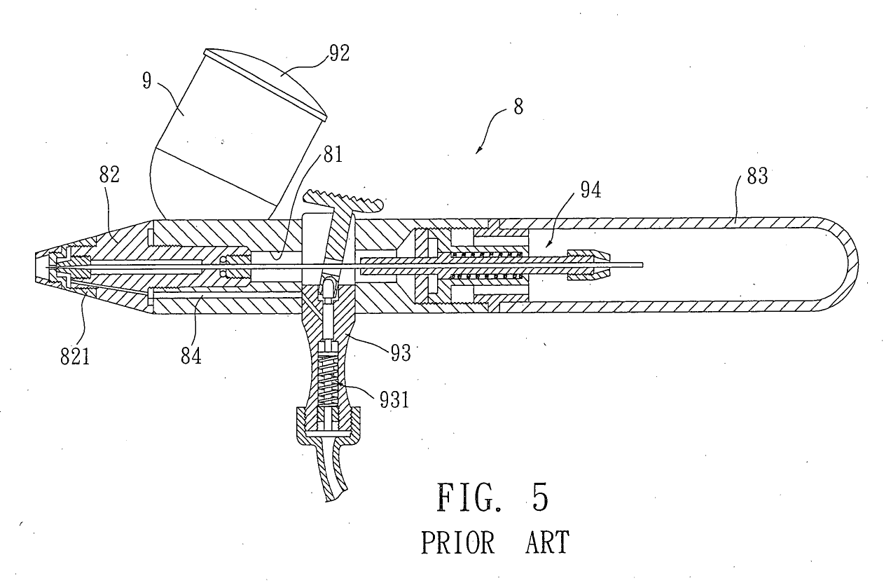

### DETAILED DESCRIPTION OF THE INVENTION

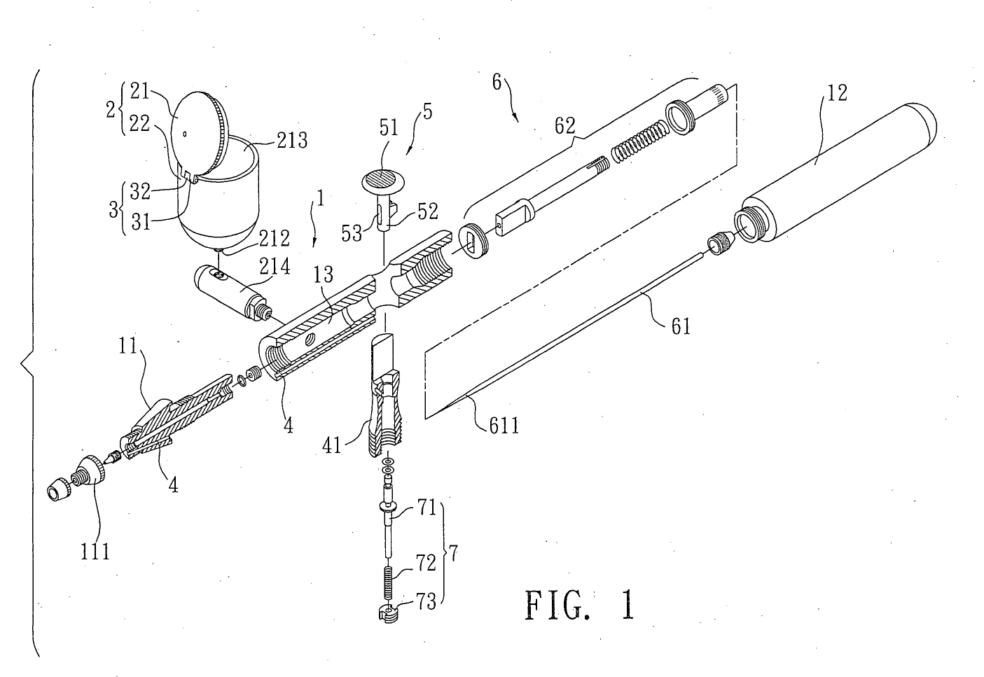

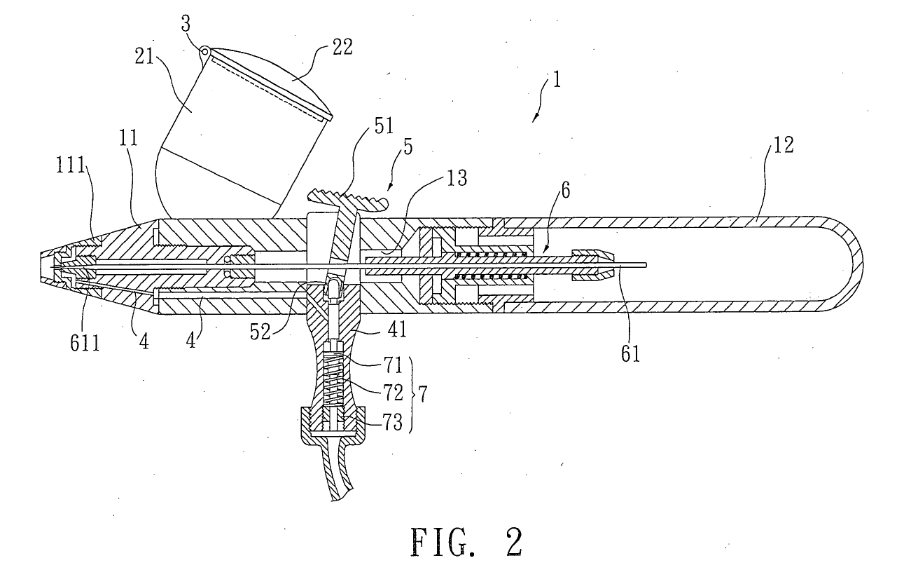

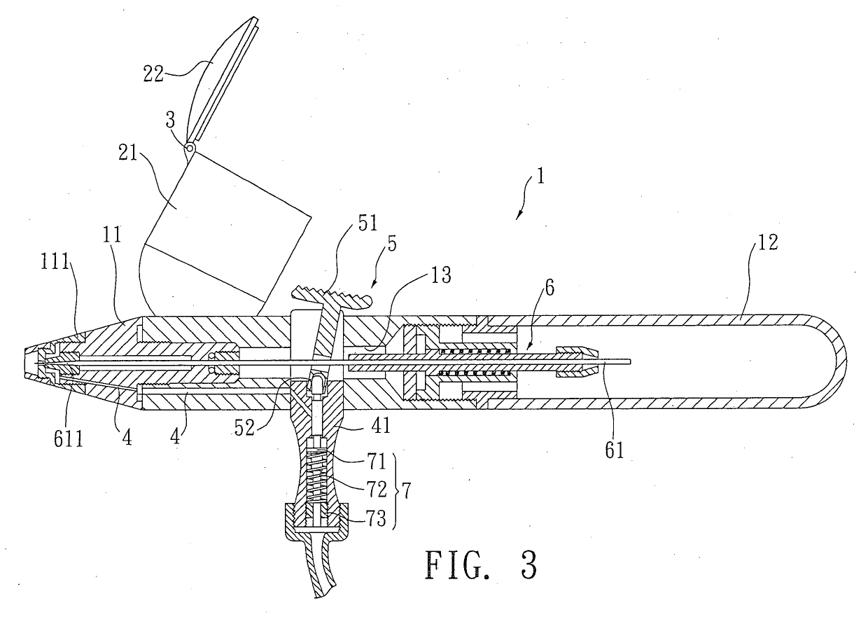

As shown in FIGS. 1 to 3, an air brush of the preferred embodiment of the present invention comprises:

A brush member 1 has a head portion 11 and a rear portion 12 at opposite end thereof. A nozzle 111 is provided at the head portion 11. The brush member 1 further has a chamber 13 and an air channel 4 therein communicated with the nozzle 111.

A paint container 2 has a cup 21 on the brush member 1, a lid 22 and a connector 3. The cup 21 has a bore 212 at a bottom to connect to the chamber 13 via a paint tube 214 and an opening 213 at a top thereof where the lid 22 is closed. The connector 3 has a first bonding portion 31 and a second bonding portion 32, wherein the first bonding portion 31 is connected to an out surface of the cup 21 adjacent to the opening 213, and the second bonding portion 32 is connected to a top of the lid 22.

A gas injection member 41 is connected to the brush member 1 and communicated with the air channel 4 to issue a high pressure gas to the nozzle 111.

An adjustment member 5 has a button portion 51, a post 52 projected from a bottom of the button portion 51 and an aperture 53 on the post 52. The post 52 is inserted into the chamber 13, and the button portion 51 is left out of the brush member 1.

A control assembly 6 is received in the chamber 13 of the brush member 1. The control assembly 6 includes a needle 61 with a tip end 611 and a control set 62. The needle 61 passes through the control set 62 and the adjustment member 5 with the tip end 611 received in the nozzle 111. The tip end 611 of the needle 61 of the control assembly 6 is moved inwards and outwards the nozzle 111 to control the paint flow.

A valve assembly 7 is received in the gas injection member 41 including a shaft 71, a spring 72 and a sleeve 73. The shaft 71 is connected to the post 52 of the adjustment member 5. The spring 72 and the sleeve 73 are fitted to shaft 71. The valve assembly 7 is adapted to open or close the gas injection member 41.

In operation, the button portion 51 of the adjustment member 5 is pressed to move the shaft 71 of the valve member 7, such that the gas is issue to the nozzle 111 via the gas injection member 41 and the air channel 4. The paint in the cup 21 of the paint container 2 flows to the chamber 13 via the bore 212 and the paint tube 214, and then flows to the nozzle 111. Now the adjustment member 5 is moved forward to move the needle 61 to select a suitable gap in the nozzle 111. A difference in pressure between inside and outside of the nozzle 111 makes the paint spray out.

The connector 3 connects the lid 21 to the cup 21 that the lid 21 still is fastened to the brush when the lid 21 is opened to fill the paint in the cup 21. As a result, the lid 21 will never be lost.

The description above is a preferred embodiment of the present invention and the equivalence of the present invention is still in the scope of the claim of the present invention.

What is claimed is:

1. An air brush, comprising:
a brush member having a head portion, on which a nozzle is provided, and an air channel communicated with the nozzle;
a paint container provided on the brush member, which has a cup and a lid, wherein the cup has an opening at a top and a bore at a bottom communicated with the brush member;
a gas injection member connected to the brush member and communicated with the air channel to issue a high pressure gas to the nozzle;
a valve assembly received in the gas injection member to control a paint flow in the nozzle, and
a connector connecting the cup and the lid to make the lid always connects the cup even when the lid is opened.

2. The air brush as defined in claim 1, wherein the connector has a first bonding portion connected to an out surface of the cup and a second bonding portion connected to a top of the lid.
